(19) United States
(12) Patent Application Publication
(10) Pub. No.: US 2007/0160288 A1
(43) Pub. Date: Jul. 12, 2007

(54) Randomly sub-sampled partition voting (RSVP) algorithm for scene change detection

(75) Inventors: Marc Hoffman, Mansfield, MA (US); Wei Zhang, Millis, MA (US); Ke Ning, Framingham, MA (US)

Correspondence Address: WOLF GREENFIELD & SACKS, P.C., 600 ATLANTIC AVENUE, BOSTON, MA, 02210-2206, US

(73) Assignee: Analog Devices, Inc., Norwood, MA (US)

(21) Appl. No.: 11/638,951

(22) Filed: Dec. 14, 2006

Related U.S. Application Data
(60) Provisional application No. 60/750,658, filed on Dec. 15, 2005.

(51) Int. Cl. G06K 9/00; G06K 9/34

(52) U.S. Cl. 382/168; 382/173

(57) ABSTRACT

A system and method for scene change detection in a video sequence employing a randomly sub-sampled partition voting (RSPV) algorithm is provided. In the video sequence, a current frame is divided into a number of partitions. Each partition is randomly sub-sampled and a histogram of the pixel intensity values is built to determine whether the current partition differs from the corresponding partition in a reference frame. A bin-by-bin absolute histogram difference between a partition in the current frame and a co-located partition in the reference frame is calculated. The histogram difference is compared to an adaptive threshold. If the majority of the examined partitions has significant changes, a scene change is detected. The RSPV algorithm is motion-independent and characterized by a significantly reduced cost of memory access and computations.

### CROSS-REFERENCE TO RELATED APPLICATION

This application claims priority under 35 U.S.C. §119(e) to U.S. Provisional Application Ser. No. 60/750,658, entitled, “RANDOMLY SUB-SAMPLED PARTITION VOTING (RSPV) ULTRA LOW COST SCENE CHANGE DETECTION ALGORITHM,” filed on Dec. 15, 2005, which is hereby incorporated by reference in its entirety.

### FIELD OF THE INVENTION

The present invention relates generally to digital video processing and analysis and, more particularly, to a system and method for scene change detection employing a randomly sub-sampled partition voting algorithm.

### BACKGROUND OF THE INVENTION

The digital video codec technology that enables video compression or decompression is an integral aspect of the telecommunication, entertainment, and broadcasting industries. Many advanced video compression standards, such as, for example, ISO/IEC MPEG-1, MPEG-2, MPEG-4, CCITT H.261, ITU-T H.263, ITU-T H.264, and Microsoft WMV9/VC-1, have been developed to deliver high quality and a low bit rate video stream.

In video compression, a video sequence is encoded using two types of frames: intra frames and predicted frames. Intra frames use only their internal information, while predicted frames exploit the temporal redundancy of a video sequence. Thus, a frame is selected as a reference, and subsequent frames are predicted from the reference. When neighboring frames have high correlation, the compression ratio of the predicted frame is much higher than that of the intra frame. In order to achieve a high compression ratio, the percentage of predicted frames within a video sequence is typically 95% or higher. However, intra frames encode a frame more efficiently than predicted frames when the frame has little correlation to the previous frame. Furthermore, intra frames are inserted in a sequence of predicted frames to avoid propagation of errors which accumulate while encoding predicted frames based on previous predicted frames.

The video sequence can be divided into different shots. A transition between two shots is a scene change. The first frame after the scene change should be encoded as an intra frame, because its correlation to the previous frame, if existing, is very low. A scene change detection algorithm is required to identify changes in the scene content of the video sequence and make a decision as to when to insert an intra frame into a succession of frames, thus segmenting video into shots.

Existing low cost scene change detection algorithms can be divided into spatial correlation-based and histogram-based. Spatial correlation-based algorithms are very sensitive to motion, while histogram-based algorithms lose most of the spatial information during their decision making process. In addition to these shortcomings, the computational complexity of these two types of algorithms is usually quite high. Therefore, they are not entirely suitable to meet the requirements of a real-time embedded video encoder, i.e., low memory access bandwidth, low computational complexity, and low latency.

### SUMMARY OF THE INVENTION

In view of the foregoing, embodiments of the invention provide a method for a reliable low cost scene change detection, utilizing a randomly sub-sampled partition voting (RSPV) algorithm. The RSPV algorithm exploits advantages of both spatial correlation-based and histogram-based algorithms.

According to embodiments of the invention, a current frame is divided into a number of partitions. Each partition is then randomly sub-sampled and a histogram of the pixel intensity values is built to determine whether the current partition differs from the corresponding partition in a reference frame. A bin-by-bin absolute histogram difference between a partition in the current frame and a co-located partition in the reference frame is calculated. The histogram difference is then compared to an adaptive threshold. If the majority of the examined partitions has significant changes, a scene change is assumed to be detected. In addition, various other thresholds can be used to determine whether a partition can be reported as significantly changed.

Employing the histogram calculation makes the RSPV algorithm motion-independent, while partitioning utilizes sufficient spatial information. Because the histogram is calculated on a sub-sampled frame, the algorithm is characterized by a significantly reduced cost of memory access and computations.

Accordingly, a number of aspects of the invention are presented, along with a number of exemplary embodiments, which are not intended as limiting.

One such aspect is a method for scene change detection in a video sequence is provided, the method comprising: (a) partitioning a current frame into a plurality of partitions each containing a plurality of pixels; (b) sub-sampling randomly said plurality of pixels within each of the plurality of partitions; (c) for each current partition from the plurality of partitions, generating a histogram of the number of pixels in each pixel value range of a plurality of pixel value ranges, the histogram comprising a plurality of bins; (d) determining a bin-by-bin absolute histogram difference between the current partition and a corresponding partition in a reference frame; (e) if the bin-by-bin absolute histogram difference is greater than a first predetermined threshold, labeling the current partition as changed; (f) repeating steps (b) through (e) for each of the plurality of partitions in the current frame; and (g) if a number of the partitions in the current frame labeled as changed is greater than a second predetermined threshold, reporting a scene change in the current partition.

According to another aspect, a computer-readable storage medium encoded with computer instructions for execution on a computer system, the instructions, when executed, performing a method for scene change detection in a video sequence, comprising: (a) partitioning a current frame into a plurality of partitions each containing a plurality of pixels; (b) sub-sampling randomly said plurality of pixels within each of the plurality of partitions; (c) for each current partition from the plurality of partitions, generating a histogram of the number of pixels in each pixel value range of a plurality of pixel value ranges, the histogram comprising a plurality of bins; (d) determining a bin-by-bin absolute histogram difference between the current partition and a corresponding partition in a reference frame; (e) if the bin-by-bin absolute histogram difference is greater than a first predetermined threshold, labeling the current partition as changed; (f) repeating steps (b) through (e) for each of the plurality of partitions in the current frame; and (g) if a number of the partitions in the current frame labeled as changed is greater than a second predetermined threshold, reporting a scene change in the current partition.

According to another aspect, an apparatus comprising a processor and a computer-readable storage medium containing computer instructions for execution on the processor to provide a method for scene change detection in a video sequence, comprising: (a) partitioning a current frame into a plurality of partitions each containing a plurality of pixels; (b) sub-sampling randomly said plurality of pixels within each of the plurality of partitions; (c) for each current partition from the plurality of partitions, generating a histogram of the number of pixels in each pixel value range of a plurality of pixel value ranges, the histogram comprising a plurality of bins; (d) determining a bin-by-bin absolute histogram difference between the current partition and a corresponding partition in a reference frame; (e) if the bin-by-bin absolute histogram difference is greater than a first predetermined threshold, labeling the current partition as changed; (f) repeating steps (b) through (e) for each of the plurality of partitions in the current frame; and (g) if a number of the partitions in the current frame labeled as changed is greater than a second predetermined threshold, reporting a scene change in the current partition.

In some embodiments, the pixel values represent a luminance component of a corresponding pixel color. The number of partitions in the current frame may be in a range from 16 to 128.

In some embodiments, the histogram may be a 16-bin histogram. The second predetermined threshold may be defined as majority of the partitions in the current frame.

It should be understood that the embodiments above-mentioned and discussed below are not, unless context indicates otherwise, intended to be mutually exclusive.

### BRIEF DESCRIPTION OF THE DRAWINGS

FIG. 1 is a schematic diagram of a video sequence including a succession of intra and predicated frames;

FIG. 2 is a schematic diagram that illustrates partitioning a frame;

FIG. 3 is a flowchart of a randomly sub-sampled partition voting algorithm according to an embodiment of the invention;

FIG. 4 is an example of a 16-bin histogram calculated as part of the randomly sub-sampled partition voting algorithm;

FIG. 5 is an example of the performance of the randomly sub-sampled partition voting algorithm on a video clip; and

FIG. 6 is a block diagram illustrating schematically a computing device implementing a method for scene change detection according to an embodiment of the invention.

### DETAILED DESCRIPTION

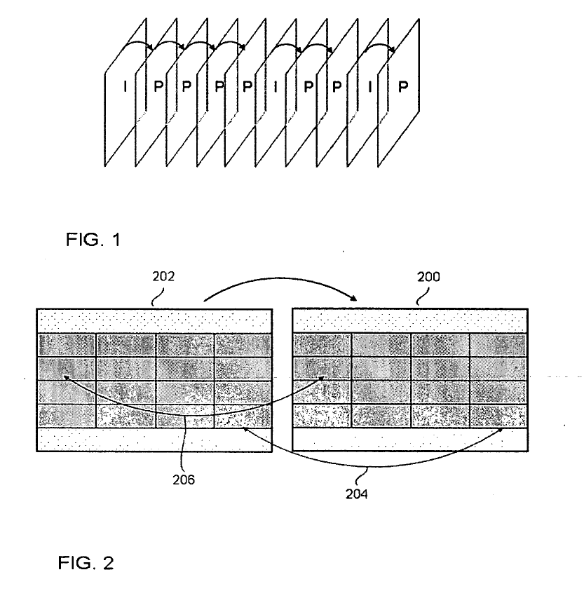

FIG. 1 shows an example of a sequence of video frames, wherein predicted (P) frames are interspersed with intra (I) frames. The I-frames are encoded completely without interpolation from any other frames, while the P-frames are encoded relative to preceding I or P frames. The goal of the scene change detection is to insert an I-frame wherever a scene change occurs.

In embodiments of the present invention, frames in a video sequence are divided into partitions. Accordingly, FIG. 2 is a schematic diagram showing a current frame 200 and a reference frame 202, each divided into a number, N, of partitions. In some embodiments, a frame is divided into 16 partitions, which provides a trade-off between spatial resolution and tolerance to motion. The number of partitions may vary. However, it should be understood that while utilizing greater number of partitions may result in increased spatial resolution, it makes the algorithm more sensitive to motion.

FIG. 2 illustrates that partitioning may not encompass the top and bottom boundaries of frames 200 and 202, because pixels in these regions typically contain relatively little information, or even no information at all (for example, when frames are “letterboxed” frames) about a scene change. Further, each partition in current frame 200 is compared to the corresponding partition in reference frame 202, as shown by arrows 204 and 206. The comparison is described in detail below.

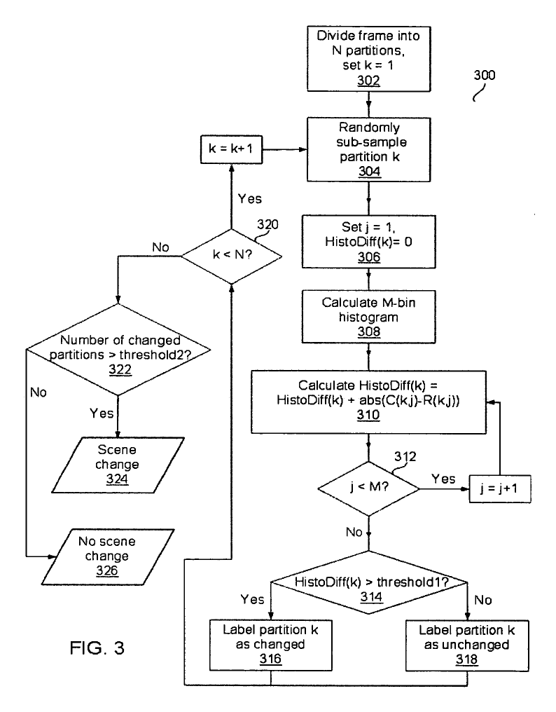

A randomly sub-sampled partition voting (RSPV) algorithm utilized in embodiments of the present invention is applied to each of the partitioned frames. FIG. 3 is a flowchart that illustrates the RSPV algorithm 300 applied to the current frame. It should be appreciated that the algorithm is applied to each successive frame, k, which is partitioned, in step 302, into N partitions as described above in connection with FIG. 2. In embodiments of the invention, the number of partitions, N, is 16, but different values of N may be used within the scope of the invention. Consequently, each partition is randomly sub-sampled using any of the suitable techniques, in step 304. For each sampling point, the random sub-sampling guarantees an equal probability of being selected. In some embodiments, the sub-sampling ratio is either 8:1 or 4:1, both horizontally and vertically. It should be noted that the luminance of the pixels is utilized in the RSPV algorithm. Other suitable pixel characteristics may also be used.

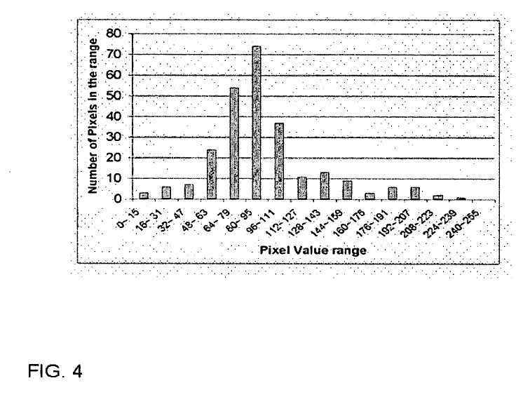

FIG. 3 shows that, for each of the N partitions, a histogram of pixel intensity values is calculated, in step 308. The histogram contains M bins. For clarity of representation, a parameter j representing a partition number is initialized to 1, in step 306. A HistoDiff variable, which will contain an absolute bin-by-bin histogram difference between a k^{th} partition in the current frame and a corresponding k^{th} partition in a previously examined reference frame, is initialized to 0, in step 306. In embodiments of the invention, as discussed above, a 16-bin histogram is utilized, which can provide a sufficient frequency domain analysis of a partition. The histogram can be built using another suitable number of bins, depending on a motion activity in the video sequence. The frequency domain representation of the partition is insensitive to motion. Therefore, the histogram allows detecting changes in the scene content independent of motion, even if the motion is high. An example of a 16-bin histogram calculated according to an embodiment of the invention is shown in FIG. 4, where each of the 16 bins contains a number of pixels in a range assigned to a certain bin.

The bin-by-bin absolute histogram difference is calculated as shown in steps 310 and 312 of FIG. 3, using the following equation:
HistoDiff(k)=Σabs(C(k,j)−R(k,j)),
where C is the current frame, R is the reference frame, k is the partition number, and j is the bin number of the histogram calculated for the k^{th} partition. FIG. 3 illustrates that each j^{th} bin from the M bins in the histogram calculated for the k^{th} partition of the current frame C is compared to the respective j^{th} bin in the k^{th} partition of the reference frame R, in step 310. It should be understood that C(k, j), which is a number of pixels within a range assigned to the j^{th} bin in the k^{th} partition of the current frame is saved for the next iteration of the PGDS algorithm where the next frame is examined, and, therefore, C(k, j) is used as R(k, j).

After the bin-by-bin absolute histogram difference between each of the M bins of respective histograms built for the k^{th} partitions from the current and reference frames has been calculated, which is determined in step 312, the resulting bin-by-bin absolute histogram difference for the k^{th} partition, HistoDiff(k), is compared to a configurable threshold, referred to as a threshold1, in step 314. If the calculated bin-by-bin absolute histogram difference exceeds the thresholds, the k^{th} partition is labeled as changed, in step 316. Otherwise, the k^{th} partition is labeled as unchanged in step 318, or not labeled as changed.

Step 320 of FIG. 3 determines if there are partitions left to be examined, and, if not all of the N partitions have been analyzed, k is incremented by 1, and the next partition, k+1, is analyzed analogously to the k^{th} partition. If in step 320 it is determined that all of the N partitions in the current frame have been examined, a number of partitions marked as changed, among the N partitions, is determined and compared to a predetermined threshold, referred to as a threshold2, in step 322. If the number of changed partitions is greater than the threshold2, a scene change is reported, in step 324. If the number of changed partitions is less than the threshold2, no scene change is reported, as shown in step 326. It should be appreciated that the threshold2 may be any suitable configurable threshold.

In embodiments of the invention, the threshold2 defined as 50% of the number of the partitions that are marked as changed. Thus, if the majority of the frame partitions (i.e., more than 8, in embodiments where the number of partitions is 16) is reported as changed, the frame is considered to contain a scene change. When the scene change occurs, the distribution of the histogram for the current frame partition is notably shifted from that for the respective reference frame partition. The magnitude of the bin-by-bin absolute histogram difference indicates the size of the distribution shift.

The computational cost of the RSPV algorithm is low. If the sub-sampling ratio is, for example, 8:1, both horizontally and vertically, the pixels processed constitute only about 2% of all pixels in the frame. Considering the nature of parallel processing of histogram calculation and memory access, the RSPV algorithm is characterized by a reduced time required for the scene change detection, compared to algorithms that calculate histograms for all pixels in a partition. Moreover, despite the sub-sampling and thus reduced number of pixels examined, the detection result is sufficiently reliable, as was demonstrated in experiments performed by the inventors. For ten well known video sequences, each having a thousand frames, a scene change missing rate is less than 3%, and the false alarm rate is less than 2%.

It should be appreciated that the RSPV algorithm can be scaled, by varying the number of partitions and the sub-sampling ratio, to fit frames of different sizes. The bin-by-bin absolute histogram difference threshold is adaptive, and can be adjusted for various video contents, including adjusting in real-time.

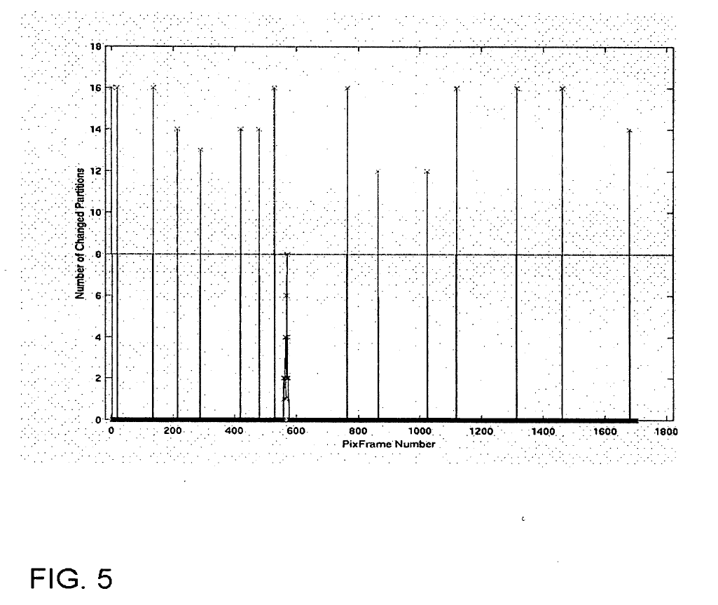

FIG. 5 illustrates an exemplary experimental result of the scene change detection on a 60 seconds long movie clip encoded utilizing a D1 frame size (720×480 pixels). The horizontal axis shows a frame number, and the vertical axis shows the number of changed partitions, wherein the total number of partitions is 16. When the number of partitions is greater than 8, a scene change is identified. Thus, the RSPV algorithm successfully differentiates scene-change frames from other frames, resulting in a high detection rate as well as in a low false alarm rate. FIG. 5 shows that, at about frame number 570, a very large object is moving quite fast, causing some noise to occur. However, because the algorithm is motion-tolerant, it provides reliable scene change detection, i.e. no scene change is falsely detected when the large object is moving across the scene.

In summary, embodiments of the present invention provide a reliable, low cost, and motion insensitive method for scene change detection. The RSPV algorithm is scalable and can employ various adaptive thresholds.

Embodiments of the present invention can be implemented in software, hardware, firmware, various types of processors, or as a combination thereof. Thus, some embodiments may be implemented as computer-readable instructions embodied on one or more computer-readable media, including but not limited to storage media such as ROMs, RAMs, floppy disks, CD-ROMs, DVDs, etc. Some embodiments of the present invention can be implemented either as a computer-readable medium having stored thereon computer-readable instructions or as hardware components of video encoders within high-performance members of the Blackfin family embedded digital signal processors available from Analog Devices, Inc., Norwood, Mass. For example, a digital signal processor ADSP-BF561, which includes two independent cores each capable of 600 MHz performance, and a single-core ADSP-BF533 digital signal processor that achieves up to 756 MHz performance may be utilized. Other various suitable digital signal processors can implement embodiments of the invention as well.

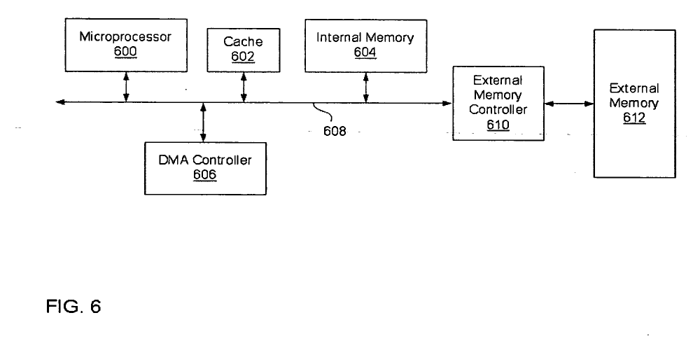

FIG. 6 is a diagram of an exemplary computing device for implementing embodiments of the present invention. Such device may include, but not limited to, a microprocessor 600, a cache memory 602, an internal memory 604, and a DMA controller 606, interconnected by a system bus 608. In embodiments of the invention implemented using the computing device of FIG. 6, the system bus 608 is connected to an external memory controller 610 which controls an external memory 612.

As should be appreciated from the foregoing, there are numerous aspects of the present invention described herein that can be used independently of one another or in any combination. In particular, various aspects of the present invention may be used alone, in combination, or in a variety of arrangements not specifically discussed in the embodiments described in the foregoing, and the aspects of the present invention described herein are not limited in their application to the details and arrangements of components set forth in the foregoing description or illustrated in the drawings. The aspects of the invention are capable of other embodiments and of being practiced or of being carried out in various ways. Various aspects of the present invention may be implemented using any type of circuit and no limitations are placed on the circuit implementation. Accordingly, the foregoing description and drawings are by way of example only.

It should also be appreciated that the phraseology and terminology used herein is for the purpose of description and should not be regarded as limiting. The use of “including,” “comprising,” or “having,” “containing”, and variations thereof herein, is meant to encompass the items listed thereafter and equivalents thereof as well as additional items.

What is claimed is:

1. A method for scene change detection in a video sequence, comprising:
a) partitioning a current frame into a plurality of partitions each containing a plurality of pixels;
b) sub-sampling randomly said plurality of pixels within each of the plurality of partitions;
c) for each current partition from the plurality of partitions, generating a histogram of the number of pixels in each pixel value range of a plurality of pixel value ranges, the histogram comprising a plurality of bins;
d) determining a bin-by-bin absolute histogram difference between the current partition and a corresponding partition in a reference frame;
e) if the bin-by-bin absolute histogram difference is greater than a first predetermined threshold, labeling the current partition as changed;
f) repeating steps b) through e) for each of the plurality of partitions in the current frame; and
g) if a number of the partitions in the current frame labeled as changed is greater than a second predetermined threshold, reporting a scene change in the current partition.

2. A method of claim 1, wherein the pixel values represent a luminance component of a corresponding pixel color.

3. A method of claim 1, wherein the number of partitions in the current frame is in a range from 16 to 128.

4. A method of claim 1, wherein the histogram is a 16-bin histogram.

5. A method of claim 1, wherein the second predetermined threshold is defined as a majority of the partitions in the current frame.

6. A computer-readable storage medium encoded with computer instructions for execution on a computer system, the instructions, when executed, performing a method for scene change detection in a video sequence, comprising:
a) partitioning a current frame into a plurality of partitions each containing a plurality of pixels;
b) sub-sampling randomly said plurality of pixels within each of the plurality of partitions;
c) for each current partition from the plurality of partitions, generating a histogram of the number of pixels in each pixel value range of a plurality of pixel value ranges, the histogram comprising a plurality of bins;
d) determining a bin-by-bin absolute histogram difference between the current partition and a corresponding partition in a reference frame;
e) if the bin-by-bin absolute histogram difference is greater than a first predetermined threshold, labeling the current partition as changed;
f) repeating steps b) through e) for each of the plurality of partitions in the current frame; and
g) if a number of the partitions in the current frame labeled as changed is greater than a second predetermined threshold, reporting a scene change in the current partition.

7. A computer-readable storage medium of claim 6, wherein the pixel values represent a luminance component of a corresponding pixel color.

8. A computer-readable storage medium of claim 6, wherein the number of partitions in the current frame is in a range from 16 to 128.

9. A computer-readable storage medium of claim 6, wherein the histogram is a 16-bin histogram.

10. A computer-readable storage medium of claim 6, wherein the second predetermined threshold is defined as a majority of the partitions in the current frame.

11. An apparatus comprising a processor and a computer-readable storage medium containing computer instructions for execution on the processor to provide a method for scene change detection in a video sequence, comprising:
a) partitioning a current frame into a plurality of partitions each containing a plurality of pixels;
b) sub-sampling randomly said plurality of pixels within each of the plurality of partitions;
c) for each current partition from the plurality of partitions, generating a histogram of the number of pixels in each pixel value range of a plurality of pixel value ranges, the histogram comprising a plurality of bins;
d) determining a bin-by-bin absolute histogram difference between the current partition and a corresponding partition in a reference frame;
e) if the bin-by-bin absolute histogram difference is greater than a predetermined threshold, labeling the current partition as changed;
f) repeating steps b) through e) for each of the plurality of partitions in the current frame; and
g) if a majority of the plurality of partitions in the current frame is labeled as changed, reporting a scene change.

12. An apparatus of claim 11, wherein the pixel values represent a luminance component of a corresponding pixel color.

13. An apparatus of claim 11, wherein the number of partitions in the current frame is in a range from 16 to 128.

14. An apparatus of claim 11, wherein the histogram is a 16-bin histogram.

15. An apparatus of claim 11, wherein the second predetermined threshold is defined as a majority of the partitions in the current frame.
